(19) United States
(12) Patent Application Publication
(10) Pub. No.: US 2003/0138233 A1
(43) Pub. Date: Jul. 24, 2003

(54) Optical attenuator

(76) Inventor: Wenhua Lin, Pasadena, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/051,621

(22) Filed: Jan. 18, 2002

(51) Int. Cl. G02B 6/00

(52) U.S. Cl. 385/140

(57) ABSTRACT

An optical attenuator is disclosed attenuator includes a waveguide ending at a reflecting surface configured to reflect light signals traveling along the waveguide. The attenuator also includes an index tuner positioned adjacent to the reflecting surface. The index tuner is configured to change the index of refraction of the waveguide adjacent to the reflecting surface.

### RELATED APPLICATIONS

This application is related to U.S. patent application Ser. No. 09/723,757, filed on Nov. 28, 2000, entitled “Formation of a Reflecting Surface on an Optical Component” and incorporated herein in its entirety.

### BACKGROUND

1. Field of the Invention

The invention relates to one or more optical networking components. In particular, the invention relates to optical attenuators.

2. Background of the Invention

Many optical networks employ optical component having one or more waveguides positioned on a base. These components can include attenuators for reducing the intensity of light signals carried by the waveguide. These attenuators often have an undesirably low efficiency. For instance, many attenuators are associated with an attenuation range that is undesirably low for use in an optical network. Another measure of attenuator efficiency is the power required to achieve a particular level of attenuation. Many attenuators require an undesirably high level of power in order to achieve a particular level of attenuation. As a result, there is a need for an attenuator that is associated with an increased efficiency.

Additionally, the size of an attenuator is often related to the attenuation range. For instance, a large attenuation range is often achieved with attenuators having several stages arranged in series. The requirement for multiple stages often results in an attenuator that requires an undesirably large amount of space on a chip. As a result, there is a need for compact attenuators that can provide the needed attenuation range without requiring a large amount of chip space.

### SUMMARY OF THE INVENTION

The invention relates to an optical attenuator. The attenuator includes a waveguide ending at a reflecting surface configured to reflect light signals traveling along the waveguide. The attenuator also includes an index tuner positioned adjacent to the reflecting surface. The index tuner is configured to change the index of refraction of the waveguide adjacent to the reflecting surface.

In one embodiment of the attenuator, a second waveguide ends at the reflecting surface. The reflecting surface is positioned to reflect a light signal from the waveguide into the second waveguide. In some instances, the index tuner is configured to change the index of refraction of a portion of the waveguide and a portion of the second waveguide.

In one embodiment of the attenuator, a light transmitting medium positioned over a base includes the waveguide. The waveguide can be positioned over a pocket formed in the base. In some instances, the portion of the base adjacent to sides of the pocket has an index of refraction greater than or equal to an index of refraction of the light transmitting medium.

The invention also relates to a method of attenuating a light signal. The method includes obtaining an optical component having a waveguide ending at a reflecting surface configured to reflect light signals traveling along the waveguide. The method also includes tuning an index of refraction of a portion of the waveguide positioned adjacent to the reflecting surface so as to reflect light signals traveling along the waveguide out of the waveguide.

### BRIEF DESCRIPTION OF THE FIGURES

FIG. 1A is a perspective view of a portion of an optical component having an attenuator. The attenuator includes a first waveguide ending at a reflecting surface and a second waveguide ending at the reflecting surface.

FIG. 1B is a perspective view of the optical component shown in FIG. 1A taken from a different direction.

FIG. 1C is a cross section of the optical component shown in FIG. 1B taken at the line labeled A.

FIG. 1D is a perspective view of another embodiment of an optical component having an attenuator. The attenuator includes a single waveguide ending at a reflecting surface.

FIG. 2A is a topview of an optical component having an attenuator.

FIG. 2B is a cross section of the attenuator shown in FIG. 2A taken at the line labeled A.

FIG. 2C is a cross section of the attenuator shown in FIG. 2A taken at the labeled B.

FIG. 3A is a topview of an optical component having an attenuator including a plurality of electrical contacts positioned on opposing sides of a waveguide.

FIG. 3B is a cross section of the attenuator shown in FIG. 3A taken along a line between the brackets labeled A.

FIG. 3C is a cross section of the attenuator shown in FIG. 3A taken along a line between the brackets labeled B.

FIG. 3D is a topview of an optical component having an attenuator including a plurality of electrical contacts positioned on opposing sides of a waveguide. The electrical contacts have different sizes.

FIG. 3E is a cross section of the attenuator shown in FIG. 3D taken along a line between the brackets labeled A.

FIG. 3F is a cross section of the attenuator shown in FIG. 3D taken along a line between the brackets labeled B.

FIG. 4 illustrates an optical component having an attenuator including a plurality of pads in electrical communication with electrical contacts.

FIG. 5A is a topview of an optical component having an attenuator with an index tuner positioned adjacent to a reflecting surface. The leading side of the index tuner is positioned at an angle relative to the reflecting surface.

FIG. 5B is a topview of an optical component having an attenuator with an index tuner positioned adjacent to a reflecting surface. The leading side of the index tuner is positioned at an angle, θ, relative to the reflecting surface. The angle, θ, is selected such that the path that each portion of a light signal travels alongside the index tuner is substantially equidistant

FIG. 6A is a topview of a portion of an optical component having an attenuator. The index tuner is spaced adjacent to the first waveguide without being positioned adjacent to the second waveguide.

FIG. 6B is a topview of a portion of an optical component having an attenuator. The index tuner is spaced adjacent to the first waveguide and the second waveguide.

FIG. 7 illustrates an optical component including a plurality of attenuators connected in series.

FIG. 8A illustrates a suitable construction of an optical component having an attenuator.

FIG. 8B illustrates another suitable construction of an optical component having an attenuator.

FIG. 9A through FIG. 9D illustrate a method of forming an optical component constructed according to FIG. 8B.

### DETAILED DESCRIPTION OF THE PREFERRED EMBODIMENT

The invention relates to an optical attenuator. The attenuator includes a waveguide ending at a reflecting surface configured to reflect light signals traveling along the waveguide. The attenuator also includes an index tuner positioned adjacent to the reflecting surface. The index tuner is configured to change the index of refraction of a portion of the waveguide located adjacent to the reflecting surface.

Light signals traveling along the waveguide are sensitive to the angle of the reflecting surface relative to the waveguide. For instance, the angle must be precise or a portion of the light signal will be reflected out of the waveguide. Because the index tuner changes the index of refraction of the waveguide adjacent to the reflecting surface, the index tuner effectively changes the angle of the reflecting surface relative to the waveguides. The change in the effective angle of the reflecting surface causes a portion of a light signal to be reflected out of the waveguides. Reflecting a portion of each light signal out of the waveguide causes attenuation of the light signals. Because the attenuator takes advantage of the sensitivity of light signals to the angle of the reflecting surface, the attenuation is more efficient than prior attenuators.

The attenuator size can be independent of the resulting attenuation range. Further, the attenuator can have a compact size. The compact size allows the attenuator to be easily integrated with other waveguide devices. The fabrication processes can be compatible with standard waveguide fabrication processes. As a result, integrating the attenuator into other waveguide devices does not substantially alter the process of fabricating those devices.

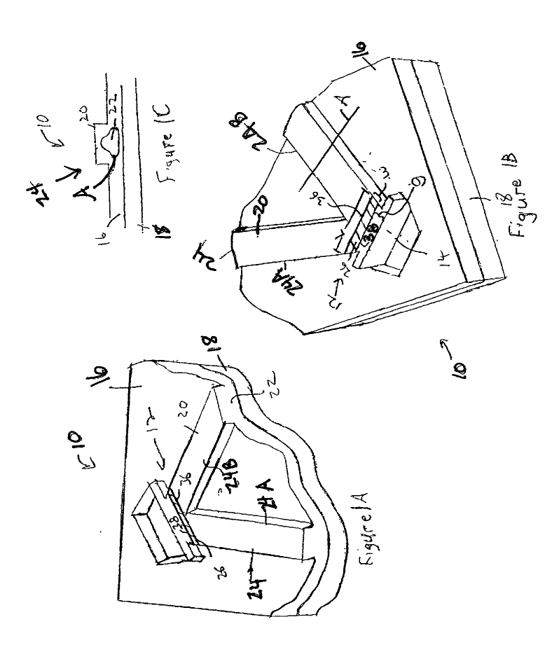

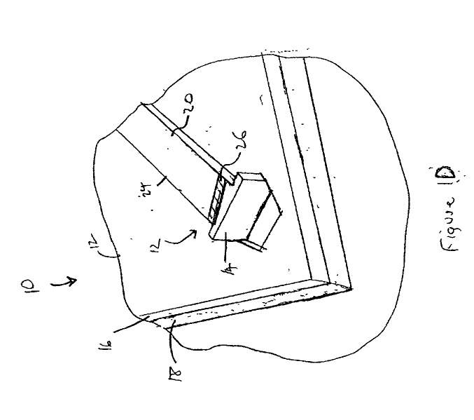

FIG. 1A provides a perspective view of a portion of an optical component 10 having an attenuator 12. The attenuator 12 includes a reflecting surface 14 for reflecting light signals. FIG. 1B provides a perspective view of the optical component 10 shown in FIG. 1A taken from a different direction. FIG. 1C is a cross section of the optical component 10 shown in FIG. 1B taken at the line labeled A.

The optical component 10 includes a light transmitting medium 16 positioned on a base 18. Suitable light transmitting media include, but are not limited to, silicon. The light transmitting medium 16 includes a ridge 20 that defines a portion of the light signal carrying region 22 of waveguides 24 where light signals are constrained. The portion of the base 18 adjacent to the light transmitting medium 16 reflects light signals from the light signal carrying region 22 back into the light signal carrying region 22. Accordingly, the base 18 defines another portion of the light signal carrying region 22. The line labeled A in FIG. 1C illustrates the profile of a light signal constrained in the light signal carrying region 22.

Although not illustrated, a cladding layer can be formed on the light transmitting medium. The cladding layer is generally selected to have a lower index of refraction than the light transmitting medium 16. For instance, when the light transmitting medium 16 is silicon, a suitable cladding layer includes, but is not limited to, silica.

The attenuator 12 includes a first waveguide 24A ending at the reflecting surface 14 and a second waveguide 24B ending at the reflecting surface 14. The reflecting surface 14 is oriented such that a light signal traveling along a first waveguide 24A is reflected into a second waveguide 24B. Reflection results from the drop in the index of refraction that occurs at the reflecting surface 14. For instance, because the air outside the waveguides 24 has an index of refraction lower than the index of refraction of the waveguides 24, light traveling along the waveguide 24 is reflected at the reflecting surface 14.

In some instances, the reflecting surface 14 is positioned so as to encourage total internal reflection. Total internal reflection can be encouraged by increasing the angle between the waveguides 24. Total internal reflection reduces the loss associated with the attenuator when the attenuator is not engaged.

An index tuner 26 is positioned adjacent to the reflecting surface 14 and is configured to change the index of refraction of a portion of the light transmitting medium 16 located adjacent to the reflecting surface 14. In some instances, the index tuner 26 is configured to reduce the index of refraction adjacent to the reflecting surface 14. The drop in the index of refraction causes reflection of light signals traveling along the waveguides 24.

Light signals traveling along the waveguide 24 are sensitive to the angle of the reflecting surface 14 relative to the waveguide 24 in that the angle must be precise or a portion of a light signal to be reflected at the reflecting surface 14 will be reflected out of the waveguides 24. The index tuner 26 is configured to reduce the index of refraction so as to effectively change the angle of the reflecting surface 14 relative to the waveguides 24. The change in the effective angle of the reflecting surface 14 causes the light signal to be reflected out of the waveguides 24. The enhanced sensitivity of the light signal to the angle of the reflecting surface 14 causes a larger portion of the light signal to be reflected out of the waveguides 24 than would occur from the drop in the index of refraction caused by the index tuner 26.

The index tuner 26 has a length labeled L in FIG. 1B. Increasing the length increases the portion of the light signal interacting with the index tuner 26. The index tuner 26 can extend across the first waveguide 24A and the second waveguide 24B as shown in FIG. 1A and FIG. 1B. The index tuner 26 has a width labeled W in FIG. 1B. As will become evident below, many index tuners are tuned by applying power to the index tuner. The amount of change to the index of refraction for a given amount of power is greatest with a narrower width, W. As a result, reducing the width can enhance the efficiency of the change in the index of refraction.

The reflecting surface and the index tuner are illustrated as being separated by a gap. As a result, the portion of a light signal reflected by the reflecting surface 14 passes the index tuner 26 more than once. The multiple interactions of the light signal with the index tuner increases the portion of the light signal that is reflected out of the waveguide 24. Accordingly, the gap can provide enhanced attenuation efficiency.

The width of the gap is labeled g in FIG. 1C. Efficient attenuation is achieved when the width of the gap is less than d as defined in Equation 1 where W is the width of the ridges 20 and φ is the angle of reflection. The value of g can be 0. Based on typical waveguide dimensions and the angles of reflection needed to achieve total internal reflection examples of suitable gap widths include, but are not limited to, gaps less than 0.1, 0.5, 1, 2, 3, 5, 10, 14 or 16 um.

d=W/(2 sin φ) (1)

FIG. 1D provides another example of a portion of an optical component 10 having an attenuator 12. The attenuator 12 includes a waveguide 24 ending at a reflecting surface 14. The reflecting surface 14 reflects light signals traveling along the waveguide 24 toward the reflecting surface 14 back into the waveguide 24. An index tuner 26 is positioned adjacent to the reflecting surface 14 and is configured to change the index of refraction of a portion of the light transmitting medium 16 located adjacent to the reflecting surface 14. As discussed above, the change in the index of refraction adjacent to the reflecting surface 14 causes a portion of each light signal traveling along the waveguide 24 to be reflected out of the waveguide 24. In some instances, a reflecting coating is formed on the reflecting surface 14 to reduce the portion of the light signals transmitted through the reflecting surface 14.

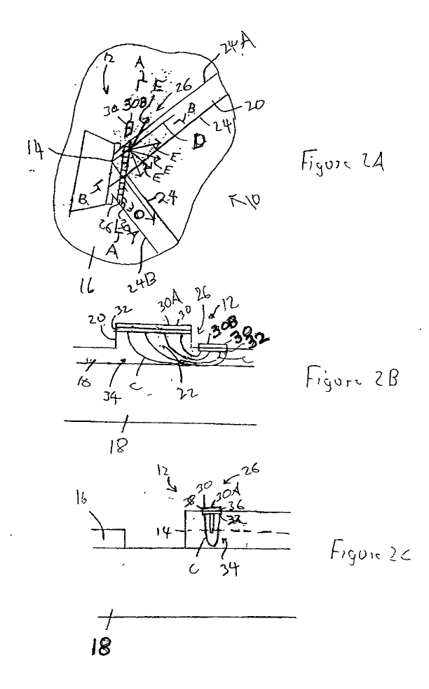

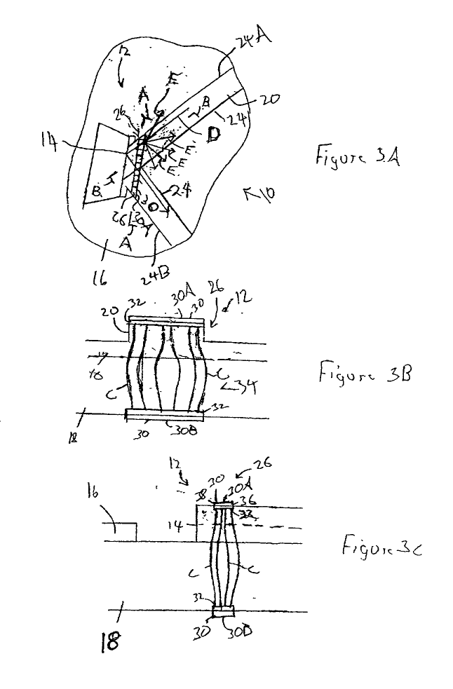

FIG. 2A through FIG. 2C illustrate a suitable index tuner 26 for use with the attenuator 12. FIG. 2A is a topview of the attenuator 12. FIG. 2B is a cross section of the attenuator 12 shown in FIG. 2A taken along a line between the brackets labeled A. FIG. 2C is a cross section of the attenuator 12 shown in FIG. 2A taken along a line between the brackets labeled B.

The index tuner 26 includes a plurality of electrical contacts 30. A first electrical contact 30A is positioned over the ridge 20 and a second electrical contact 30B is positioned adjacent to the ridge 20. Suitable metals for the electrical contacts 30 include, but are not limited to, Ni, Cr, Ti, Tungsten, Au, Ct, Pt, Al and/or their silicides. The electrical contacts 30 can be formed to a thickness greater than 0.1 μm, 0.5 μm, 1 μm, 1.5 μm or 2 μm. Electrical conductors such as wires can optionally be connected to the electrical contacts 30 for applying a potential between the first electrical contact 30A and the second electrical contact 30B.

A doped region 32 is formed adjacent to each of the electrical contacts 30. The doped regions 32 can be N-type material or P-type material. When one doped region 32 is an N-type material, the other doped region 32 is a P-type material. For instance, the doped region 32 adjacent to the first electrical contact 30A can be a P type material while the material adjacent to the second electrical contact 30B can be an N type material. In some instances, the doped regions 32 of N type material and/or P type material are formed to a concentration of 10\hat{ }(17−21)/cm³ at a thickness of less than 6 μm, 4 μm, 2 μm, 1 μm or 0.5 μm.

During operation of the attenuator 12, a potential is applied between the electrical contacts 30. The potential causes the index of refraction of the first light transmitting medium 16 positioned between the electrical contacts 30 to change as shown by the lines labeled C. Accordingly, the lines labeled C denote the location of an index changed region 34 where the index of refraction of the light transmitting medium 16 is changed. When the potential on the electrical contact 30 adjacent to the P-type material is less than the potential on the electrical contact 30 adjacent to the N-type material, a current flows through the light transmitting medium 16. The current reduces the index of refraction of the index changed region 34 below the index of refraction outside the index changed region 34.

The line labeled D in FIG. 2A illustrates a light signal traveling toward the attenuator 12. When the index tuner 26 is operated so as to reduce the index of refraction of the light signal carrying region 22, the drop in the index of refraction causes at least a portion of the light signal to be reflected out of the light signal carrying region 22 as illustrated by the lines labeled E.

Increasing the potential applied between the electrical contacts 30 increases drop in the index of refraction. The increased drop in the index of refraction increases the portion of the light signal that is attenuated.

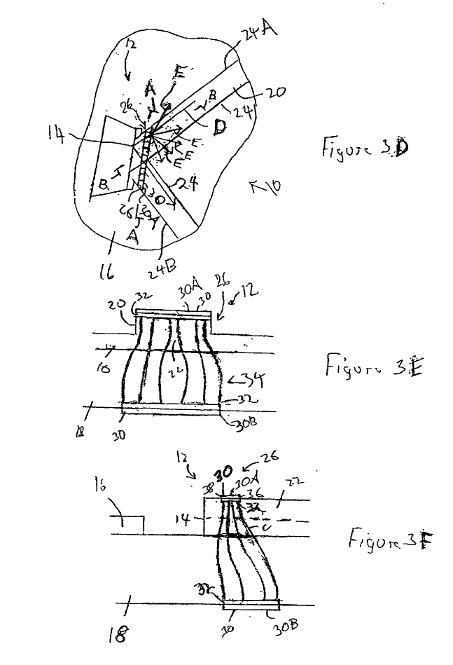

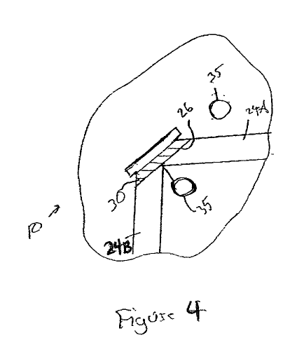

FIG. 3A through FIG. 3C illustrate another suitable construction of an index tuner 26. FIG. 3A through FIG. 3C illustrate a suitable index tuner 26 for use with the attenuator 12. FIG. 3A is a topview of the attenuator 12. FIG. 3B is a cross section of the attenuator 12 shown in FIG. 3A taken along a line between the brackets labeled A. FIG. 3C is a cross section of the attenuator 12 shown in FIG. 3A taken along a line between the brackets labeled B. The dashed line shown in FIG. 3C shows the location of the base of the ridge 20.

The attenuator 12 includes a first electrical and a second electrical contact 30B positioned on opposing sides of the optical component 10. Doped regions 32 are formed adjacent to each of the electrical contacts 30. When one doped region 32 is an N-type material, the other doped region 32 is a P-type material. During operation of the attenuator 12, a potential is applied between the electrical contacts 30. The potential causes the index of refraction of the first light transmitting medium 16 positioned between the electrical contacts 30 to change as shown by the lines labeled C in FIG. 3B and FIG. 3C. When the potential on the electrical contact 30 adjacent to the P-type material is less than the potential on the electrical contact 30 adjacent to the N-type material, a current flows through the light transmitting medium 16 and the index of refraction decreases.

The line labeled D in FIG. 3A illustrates a light signal traveling toward the attenuator 12. When the index tuner 26 is operated so as to reduce the index of refraction of the light signal carrying region 22, the drop in the index of refraction causes at least a portion of the light signals to be reflected out of the light signal carrying region 22 as illustrated by the line labeled E.

The first electrical contact 30A and the second electrical contact 30B can have different shapes and/or different sizes. For instances, FIG. 3D through FIG. 3F illustrate a first electrical contact 30A and a second electrical contact 30B having different sizes. FIG. 3D is a topview of the attenuator 12. FIG. 3E is a cross section of the attenuator 12 shown in FIG. 3D taken along a line between the brackets labeled A. FIG. 3F is a cross section of the attenuator 12 shown in FIG. 3D taken along a line between the brackets labeled B. The dashed line shown in FIG. 3F shows the location of the base of the ridge 20.

The second electrical contact 30B is larger than the first electrical contact 30A. As evident from the line labeled C in FIG. 3F, the different sizes result in an index changed region 34 that is less vertical than the index changed region 34 of FIG. 3A through FIG. 3C. Accordingly, the different sizes reduce the verticality of the index changed region. This reduced verticality can increase the portion of the light signals that are reflected out of the light signal carrying region 22. As a result, the different sizes can increase the verticality of the attenuator 12.

As evident in FIG. 3F, the electrical contacts 30 can be off center relative to one another. Increasing the degree that the electrical contacts are off center relative to one another can also reduce the verticality of the index changed region 34. As a result, arranging the electrical contacts 30 so as to be off center relative to one another can provide a more efficient attenuator. Although the off center nature of the electrical contacts 30 is illustrated in the context of electrical contacts 30 having different sizes, increased attenuator efficiency can be achieved with electrical contacts 30 that are the same size and off center relative to one another.

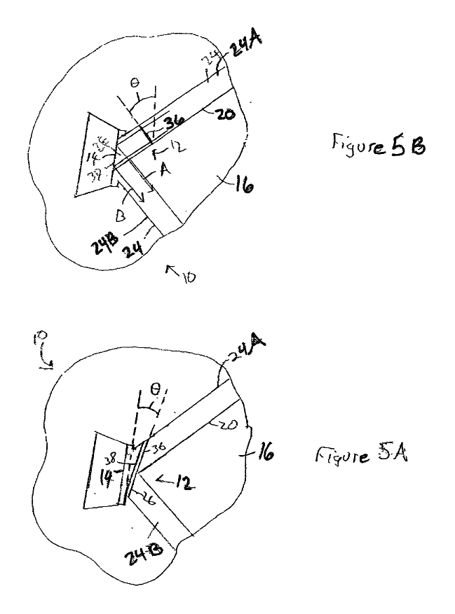

FIG. 4 illustrates electrical contacts 30 in electrical communication with pads 35. As an alternative to connecting electrical contacts directly to the electrical conductors, the pads 35 can be connected to the electrical conductors for applying a potential to the electrical contacts. The pads 35 can be located remote from the waveguides. A pad 35 and the connected electrical contact can be located on the opposite sides of the component 10.

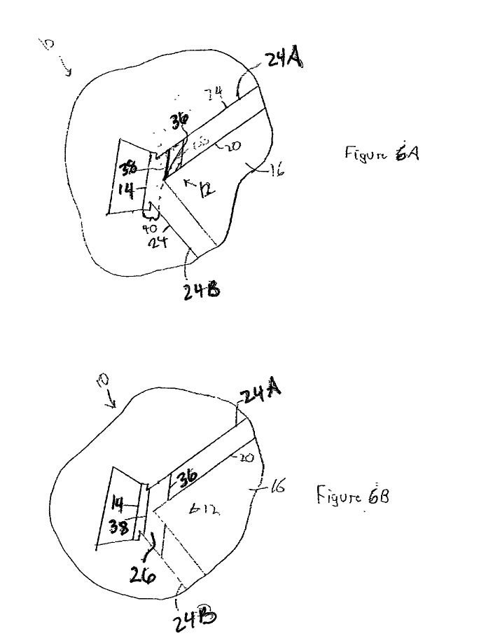

The leading side 36 of an index tuner 26 is the first side of the index tuner 26 that the light signal passes as the light signal travels toward the reflecting surface 14. Although FIG. 2A and FIG. 3A each show the leading side 36 of the first electrical contact 30A as being substantially parallel to the reflecting surface 14, the leading side 36 can be angled relative to the reflecting surface 14. For instance, FIG. 5A illustrates the first electrical contact 30A of an index tuner 26 positioned at an angle, θ, relative to the reflecting surface 14. The angle, θ, causes the leading side 36 of the index changed region 34 to be angled relative to the reflecting surface 14. The angle of the index changed region 34 can enhance the combined effect of the reflecting surface 14 and the index tuner 26. As a result, the angle, θ, can provide more efficient attenuation. A suitable magnitude for the angle θ includes, but is not limited to angles in the range of zero to the up to the angle of reflection.

The angle, θ, can be selected to achieve particular pathlengths through the index changed region 34. For instance, FIG. 5B illustrates the angle, θ, selected such that the path that each portion of a light signal travels through the index changed region 34 is substantially equidistant. The arrow labeled A denotes the path that a first portion of a light signal travels through an index changed region 34 and the arrow labeled B denotes the path that a second portion of a light signal travels through the index changed region 34. The first portion of the light signal and the second portion of the light signal travel along different paths through the index changed region 34. The angle, θ, is selected such that pathlength of the first portion of the light signals through the index changed region 34 is substantially the same as the pathlength of the second portion of the light signal through the index changed region 34. This arrangement encourages each portion of the light signal to exit the index changed region 34 in about the same phase.

The following side 38 of an index tuner 26 is the first side of the index tuner 26 that the light signal passes after being reflected off the reflecting surface 14. Although FIG. 2A and FIG. 3A each show the following side 38 of the index tuner 26 as being spaced apart from the reflecting surface 14, the following side 38 can be positioned next to the reflecting surface 14 as is evident in FIG. 5B.

The leading side 36 and the following side 38 can be parallel to one another as illustrated in FIG. 5A or can have different angles relative to the reflecting surface as shown in FIG. 5B.

The index tuner 26 can be configured to change the index of refraction of the first waveguide 24A without changing the index of refraction of the second waveguide 24B or to change the index of refraction of the second waveguide 24B without changing the index of refraction of the first waveguide 24A. For instance, the index tuner 26 can be positioned adjacent to the first waveguide 24A as shown in FIG. 6A. The index tuner is not is not positioned over the common region 40 shared by the first waveguide 24A and the second waveguide 24B. As a result, the index tuner 26 forms an index changed region 34 that is located primarily in the first waveguide 24A.

The index tuner can be positioned adjacent to the common region 40 and the first waveguide 24A and/or the second waveguide 24B. For instance, FIG. 6B illustrates the index tuner 26 positioned adjacent to the common region 40 and adjacent to the first waveguide 24A and the second waveguide 24B.

Although FIG. 6A and FIG. 6B illustrate the index tuner 26 spaced apart from the reflecting surface 14, the index tuner 26 can be positioned next to the reflecting surface. Additionally, the following edge can be angled relative to the reflecting surface 14. Suitable dimensions for the largest distance between the following side 38 and the reflecting surface 14 include, but are not limited to, dimensions less than d as determined according to Equation 1.

The degree of attenuation provided by the index tuners 26 illustrated above changes as the index changed region 34 changes. For instance, increasing the potential applied between the electrical contacts 30 of an index tuner 26 constructed according to FIG. 2A can increase the drop in the index of refraction in the index changed region 34. The increased drop in the index of refraction increases the degree of attenuation. Additionally, increasing the potential applied between the electrical contacts 30 of an index tuner 26 constructed according to FIG. 2A can increase the size and/or shape of the index changed region 34. This change to the geometry of the index changed region can also increase the degree of attenuation.

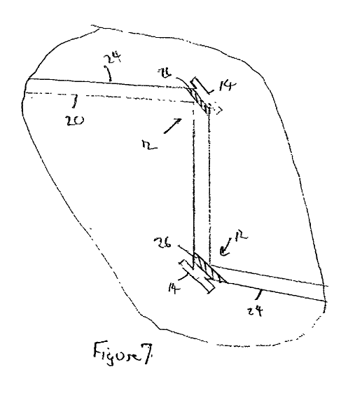

In some instances, the maximum degree of attenuation that can be achieved is less than 100% attenuation. More specifically, in some instances, applying additional potential between the electrical contacts 30 does not provide additional attenuation. A plurality of attenuators 12 can be employed in order to increase the attenuation range. For instance, two or more attenuators 12 can be connected in series as shown in FIG. 7. In order to achieve high degrees of attenuation, this arrangement of attenuators 12 can have lower power requirements than a single attenuator 12 providing the same degree of attenuation. Further, when high degrees of attenuation are desired, the number of attenuators 12 can be increased until substantially complete attenuation is achieved.

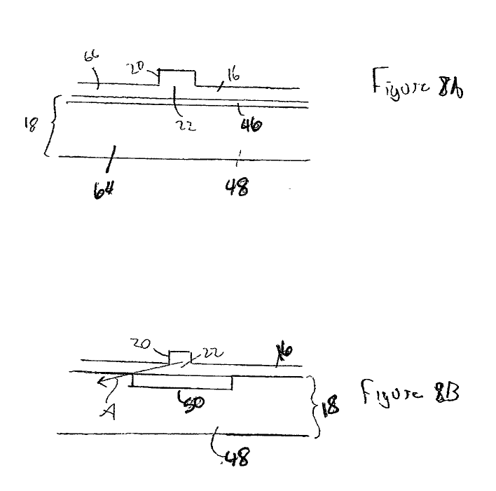

The base 18 can have a variety of suitable constructions. FIG. 8A is a cross section of a waveguide 24 formed on a base 18 having a light barrier 46 positioned over a substrate 48. The light barrier 46 is selected to reflect light signals from the light signal carrying region 22 back into the light signal carrying region 22. A suitable material for the substrate 48 and light transmitting medium 16 includes, but is not limited to, silicon. A suitable light barrier 46 includes, but is not limited to, silica.

A silicon on insulator wafer can be employed to fabricate an attenuator according to FIG. 8A. A silicon on insulator wafer typically includes a layer of silica positioned between a lower silicon layer 64 and an upper silicon layer 66. The lower silicon layer 64 serves as the substrate 48; the silica serves as the light barrier 46; and the upper silicon layer 66 serves as the light transmitting medium 16. The methods taught in U.S. patent application Ser. No. 09/723,757, filed on Nov. 28, 2000, entitled “Formation of a Reflecting Surface on an Optical Component” and incorporated herein in its entirety can be employed to form the reflecting surface 14 in the upper silicon layer 66. The doped regions 32 can be formed at the desired locations using techniques such as impurity diffusion or masking and ion implantation. The electrical contacts 30 are formed over the doped regions 32.

FIG. 8B illustrates another embodiment of a suitable base 18. The base 18 includes a substrate 48 having a pocket 50. The ridge 20 is positioned over the pocket 50. The pocket 50 contains a material configured to reflect a light signal from the light signal carrying region 22 back into the light signal carrying region 22. Suitable materials for the substrate 48 include, but are not limited to, silicon. Suitable materials for containing in the pocket 50 include, but are not limited to, solids and fluids such as air.

The substrate 48 can be selected such that light can be drained from the light transmitting medium 16 into the substrate 48 as illustrated by the arrow labeled A. As a result, portions of a light signal driven out of the light signal carrying region 22 by attenuation are drained away from the light signal carrying regions 22. Because the attenuated light signals are drained away from the light signal carrying regions 22, the attenuated light signals do not act as source of cross talk by entering into the light signal carrying regions 22 of other waveguides 24 on the optical component 10. A suitable method of achieving the drain effect is to select the substrate 48 so as to have an index of refraction greater than or equal to the index of refraction of the light transmitting medium 16. This selection of materials reduces reflection that occurs at the intersection of the substrate 48 and the light transmitting medium 16. In some instances, the substrate 48 and the light transmitting medium 16 are the same material.

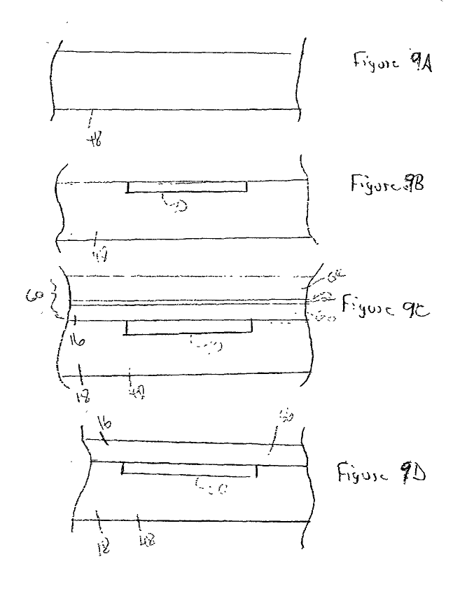

FIG. 9A through FIG. 9D illustrate a method for fabricating an optical component 10 constructed according to FIG. 8B. FIG. 9A is a cross section of a base 18. A suitable base 18 includes, but is not limited to, a silicon substrate 48. Although the base 18 is shown as being constructed from a single material, the base 18 can have a composite construction or can be constructed with two or more layers of material.

One or more pockets 50 are formed in the base 18 as illustrated in FIG. 9B. The one or more pockets 50 can be formed with a mask and an etch or other techniques. As illustrated above, the pocket 50 is positioned under the ridge(s) 20 that define the waveguides 24. Accordingly, the pocket 50 is formed so the ridge(s) 20 can be formed over the pocket 50 in the desired pattern.

A light transmitting medium 16 is formed over the base 18. The light transmitting medium 16 can be deposited or grown on the base 18. Alternatively, wafer bonding techniques can be employed to bond the light transmitting medium 16 of a wafer 60 to the base 18. A suitable wafer 60 includes, but is not limited to, a silicon on insulator wafer 60. As noted above, a silicon on insulator wafer 60 typically includes a layer of silica 62 positioned between a lower silicon layer 64 and an upper silicon layer 66. The upper silicon layer 66 can be bonded to the base 18 as shown in FIG. 9C. The lower silicon layer 64 and the layer of silica 62 can be removed to provide the optical component 10 precursor shown in FIG. 9D. Additionally, a portion of the upper silicon layer 66 can be removed to provide the upper silicon layer 66 with the desired thickness of the light transmitting medium 16. Suitable methods for removing the lower silicon layer 64, the layer of silica 62 and the upper silicon layer 66 include, but are not limited to, etching, buffing, polishing, lapping, detachment through H implantation and subsequent annealing. The methods taught in U.S. patent application Ser. No. 09/723,757, filed on Nov. 28, 2000, entitled “Formation of a Reflecting Surface on an Optical Component” and incorporated herein in its entirety can be employed to form the waveguide(s) 24 and reflecting surface 14 in the light transmitting medium 16. The doped regions 32 can be formed at the desired locations using techniques such as impurity diffusion or masking and ion implantation. The electrical contacts 30 are formed over the doped regions 32.

The methods described in U.S. patent application Ser. No. 09/723,757 include etching the light transmitting medium 16 so as to form ridge(s) 20 in the light transmitting medium 16. In order to reduce scattering of light signals, the etches should be selected so as to result in formation of smooth surfaces on the ridge 20. Suitable etches include, but are not limited to, the etches taught in U.S. patent application Ser. No. 09/845,093; filed on Apr. 27, 2001; entitled “Formation of an Optical Component Having Smooth Sidewalls” and U.S. patent application Ser. No. 09/690,959; filed on Oct. 16, 2000; entitled “Formation of a Vertical Smooth Surface on an Optical Component” each of which is incorporated herein in is entirety.

Although many of the index tuner 26 principles are disclosed in the context of an attenuator 12 having a first waveguide 24A and a second waveguide 24B ending at a reflecting surface 14, the same principles can be applied to an attenuator 12 having a single waveguide 24 ending at a reflecting surface 14 as disclosed in FIG. 1D.

Although the index tuners 26 disclosed above include a plurality of electrical contacts 30, a variety of other index tuners 26 can be used in conjunction with the attenuator 12. For instance, each index tuner 26 can be a temperature control device such as a cooler. Reducing the temperature of the light transmitting medium 16 causes the index of refraction of the light transmitting medium 16 to drop. Additionally, the index of refraction of a light transmitting medium 16 often changes in response to application of a force to the light transmitting medium 16. As a result, the index tuner 26 can apply a force to the light transmitting medium 16. A suitable index tuner 26 for application of a force to the light transmitting medium 16 is a piezoelectric crystal. Further, the index of refraction of a light transmitting medium 16 often changes in response to application of a magnetic field to the light transmitting medium 16. As a result, the index tuner 26 can apply a tunable magnetic field to the light transmitting medium 16. A suitable device for application of a magnetic field to the light transmitting medium 16 is a magnetic-optic crystal.

Although the attenuator is disclosed in the context of optical components having ridge waveguides, the principles of the present invention can be applied to optical components having other waveguide types. Suitable waveguide types include, but are not limited to, buried channel waveguides and strip waveguide.

Although the index tuners illustrated above are shown as having straight sides, the index tuners can have one or more curved sides that can further enhance the attenuation efficiency.

When the attenuator is configured to provide high degrees of attenuation, the attenuator can serve as a power blocker.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. An optical attenuator, comprising:
a waveguide ending at a reflecting surface configured to reflect light signals traveling along the waveguide; and
an index tuner positioned adjacent to the reflecting surface, the index tuner configured to change an index of refraction of the waveguide adjacent to the reflecting surface.

2. The attenuator of claim 1, further comprising:
a second waveguide ending at the reflecting surface, the reflecting surface positioned to reflect a light signal from the waveguide into the second waveguide.

3. The attenuator of claim 2, wherein the index tuner is configured to change the index of refraction of the waveguide and of the second waveguide.

4. The attenuator of claim 2, wherein the index tuner is positioned adjacent to a portion of the first waveguide and adjacent to a portion of the second waveguide.

5. The attenuator of claim 1, wherein the index tuner is spaced apart from the reflecting surface.

6. The attenuator of claim 5, wherein the index tuner is spaced apart from the reflecting surface at a distance less than 16 μm.

7. The attenuator of claim 5, wherein the index tuner is spaced apart from the reflecting surface at a distance less than 8 μm.

8. The attenuator of claim 1, wherein the index tuner includes two or more electrical contacts.

9. The attenuators of claim 8, wherein at least two of the electrical contacts are positioned adjacent to doped regions.

10. The attenuator of claim 8, wherein an electrical contact is positioned over the waveguide and another electrical contact is positioned adjacent to the waveguide.

11. The attenuator of claim 8, wherein an electrical contact is positioned over the waveguide and another electrical contact is positioned under the waveguide.

12. The attenuator of claim 11, wherein the electrical contact over the waveguide and the electrical contact under the waveguide have different sizes.

13. The attenuator of claim 11, wherein the electrical contact over the waveguide and the electrical contact under the waveguide have different shapes.

14. The attenuator of claim 11, wherein the electrical contact over the waveguide and the electrical contact under the waveguide are positioned off center relative to one another.

15. The attenuator of claim 1, wherein the waveguide is defined in a light transmitting medium positioned over a base.

16. The attenuator of claim 15, wherein the waveguide is formed over a pocket formed in the base.

17. The attenuator of claim 16, wherein a portion of the base adjacent to sides of the pocket has an index of refraction greater than or equal to an index of refraction of the light transmitting medium.

18. A method of attenuating a light signal, comprising:
obtaining an optical component having a waveguide ending at a reflecting surface configured to reflect light signals traveling along the waveguide; and
tuning an index of refraction of a portion of the waveguide positioned adjacent to the reflecting surface so as to reflect light signals traveling along the waveguide out of the waveguide.

19. The method of claim 18, wherein tuning the index of refraction of the portion of the waveguide includes reducing the index of refraction of the portion of the waveguide.

20. The method of claim 18,wherein wherein tuning the index of refraction of the portion of the waveguide includes forming an electrical current through the portion of the waveguide.
